(19) United States
(12) Patent Application Publication
(10) Pub. No.: US 2008/0264139 A1
(43) Pub. Date: Oct. 30, 2008

(54) Method and Apparatus for Manufacturing Precision Parts

(76) Inventors: Ronald A. Rosenbohm, Sturgeon Bay, WI (US); Gregory W. Conrad, Plainfield, IL (US)

Correspondence Address: HOWREY LLP - DC, C/O IP DOCKETING DEPARTMENT, 2941 FAIRVIEW PARK DR, SUITE 200, FALLS CHURCH, VA, 22042-2924, US

(21) Appl. No.: 12/066,632

(22) PCT Filed: Sep. 15, 2006
(86) PCT No.: PCT/US06/36094

§ 371 Date: Jun. 25, 2008

Related U.S. Application Data
(60) Provisional application No. 60/718,027, filed on Sep. 15, 2005.

(51) Int. Cl. B21D 43/00; B23P 13/04

(52) U.S. Cl. 72/419; 29/558

(57) ABSTRACT

The invention relates to an improved method and apparatus for manufacturing metal parts, preferably surgical blades (1), using bandoliering with die stamping and machining processed material at stations on the die. The method allows for cost efficient mass production while maintaining a high level of precision.

### CROSS-REFERENCE TO RELATED APPLICATIONS

The invention claims priority to provisional application US60/718,027 filed on Sep. 15, 2005, the content of which is incorporated herein by reference.

### FIELD OF THE INVENTION

The invention relates to apparatus and methods for manufacturing precision metal parts by using a combination of machining and progressive dies.

### BACKGROUND

Bandoliering is commonly employed in manufacturing when using progressive dies. Starting material may be attached to a single or double bandolier at certain spacing. It allows for the mass production of metal objects using die stamping by carrying the metal object through a die automatically for processing. Although the process allows for the mass production of fabricated metals, it is not efficient for manufacturing precision devices such as surgical blades for several reasons including: 1) the process is cost prohibitive due to high tonnage requirements and interrupted flow of material, and 2) the products of metal stamping using dies are not as precise and have inferior surface finish compared to machined parts. The present invention addresses these problems by a method making it possible to mass produce precision devices or parts such as surgical blades by bandoliering using progressive dies.

### SUMMARY OF THE INVENTION

The present invention is directed to a method and apparatus for manufacturing precision metal parts, preferably surgical blades, that fulfills the considerations stated above. The method uses a bandolier to which the blade material is attached. The blade material is formed at various stations in one or more progressive dies. The first station coins the blade material to the correct volume leaving excess material unrestricted. The excess material is trimmed away to the correct volume of the finished blade cross section. The second station coins only the top of the blade material leaving the bottom flat to promote material flow. The edges of the blade material are coined to a thickness that matches the finished product at this station. The third station reforms the blade material to the net shape whereupon tools for machining radii on the ends of the blade material are applied.

The method of the present invention has the advantages of mass production of precision parts with machined edges and superior surface finish with little variation between parts that cannot be achieved by machining or progressive die stamping alone.

### BRIEF DESCRIPTION OF THE DRAWINGS

The invention will now be further elucidated by way of exemplary embodiments that form no limitation to the appended claims, and with reference to the following drawings.

FIGS. 1A-1C illustrates a finished surgical blade, the preferred embodiment of the product manufactured by the claimed process.

FIG. 2 is a schematic diagram of the progressive die apparatus.

FIGS. 3A-3B is a plan view of the first coining station.

FIGS. 4A-4B is a plan view of the second coining station.

FIGS. 5A-5B is a plan view of the third coining station.

FIGS. 6A-6C are elevation and plan views of finished surgical blades attached to the bandolier.

FIG. 7 is a schematic diagram of machining tools for forming machined edges on the finished surgical blades.

### DETAILED DESCRIPTION OF THE INVENTION

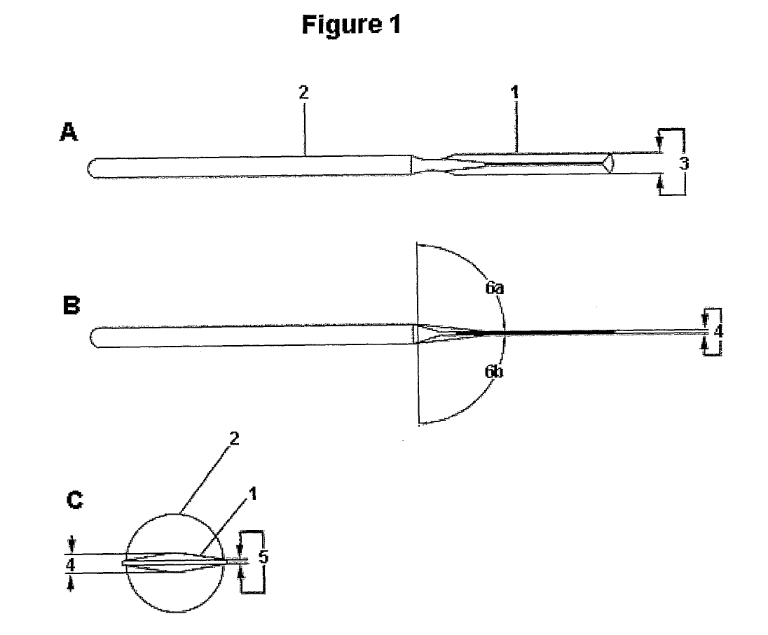

Referring now to the drawings in detail, wherein like reference numerals indicate like elements throughout the several views, there is illustrated in FIG. 1A-1C a surgical blade 1, the preferred embodiment of the product produced by the claimed process. The die tooling described below manufactures the blade 1 attached to the uncoined handle 2 through several coining and trimming processes to obtain the final dimensions of the desired blade width 3 and thickness 4 and edge thickness 5. The finished blade 1 is capable of bending 90 degrees up and down across the narrow section (6a and 6b) without breakage.

### Die Apparatus

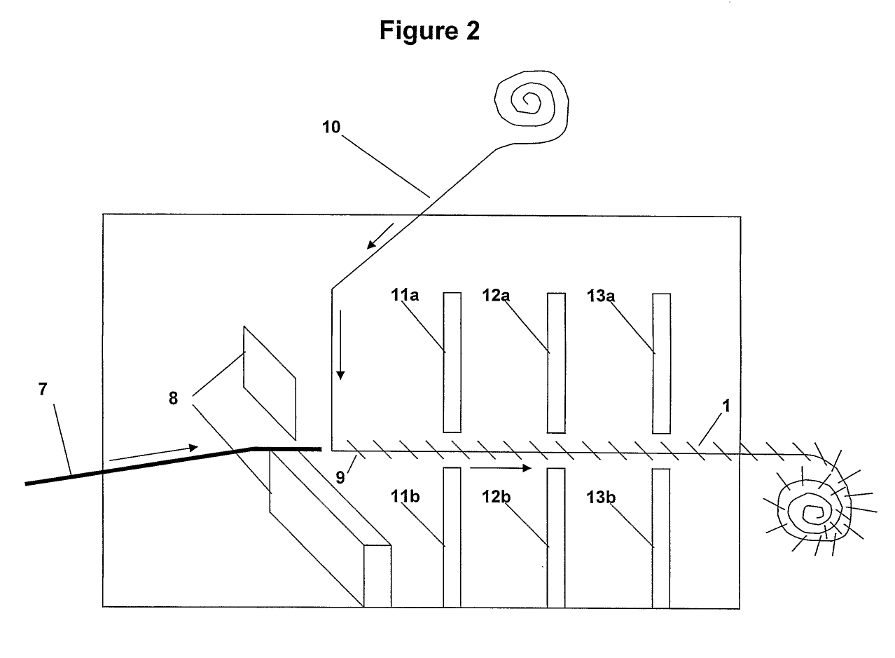

FIG. 2 shows a schematic diagram of a progressive die in accordance with an embodiment of the present invention. Wire stock 7 enters the die and is cut to length by a cutting apparatus 8. The metal blank 9 cut from the wire stock 7 is attached to a bandolier 10 at a portion of the metal blank 9 that will not be coined. The bandolier carries the metal blank 9 to the first coining station 11 wherein the metal blank 9 is coined to a thickness thinner than the finished thickness 4 in one hit. The excess material is restricted and the bandolier 10 carries the metal blank 9 to the second coining station 12 where the thickness of the edges of the metal blank 9 are coined to the thickness of the finished product 5. The bandolier 10 then carries the metal blank 9 to the third coining station 13 which reforms the metal blank 9 to it final shape of the surgical blade 1. The finished blades 1 may remain on the coiled bandolier 10 for further processing.

### First Coining Station

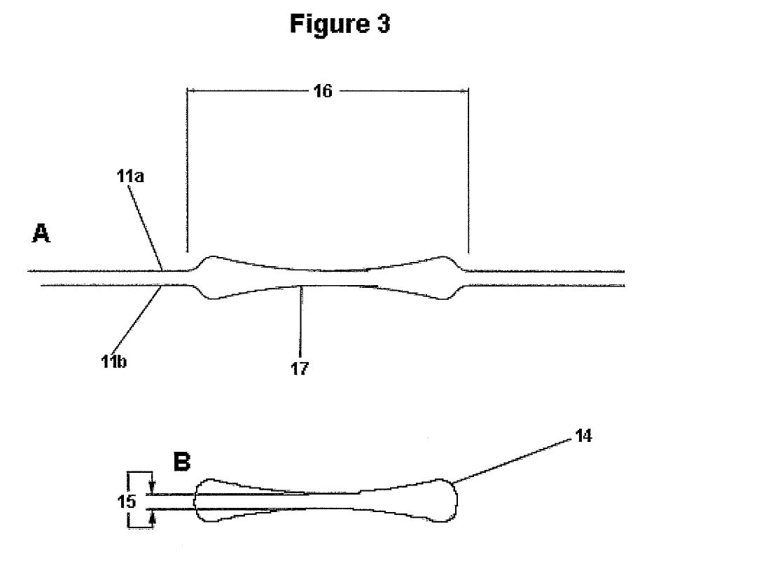

The bandolier 10 carries the metal blank 9 to the first coining station 11 comprising an upper coining die 11a and a lower coining die 11b as shown in FIG. 2. FIG. 3A illustrates the first coining station wherein a portion of the metal blank 9 is coined to the correct volume and excess material is restricted. FIG. 3B shows the profile of the metal blank 9 following action of the first coining station 11 wherein the metal blank 9 is coined into an hourglass (convex) configuration 14. The thickness 15 of the metal blank 9 is thinner than the thickness 4 of the finished product 1 in one hit. Coining by one hit reduces the effect of work hardening the material and reduces the tonnage required for coining at subsequent stations. Moreover, the first coining station is shaped with a radius having an area 16 for the material to flow and polished to further facilitate material to flow out from the center 17. It is preferred that upon action of the first coining station 11 the thickness 15 of the metal blank is at least 75% of the thickness 4 of the finished product. The thickness 15 of the metal blank 9 having the hourglass configuration 14 facilitates the flow of material back to the center 17 at subsequent coining stations allowing greater precision in forming the edges of the finished product. Upon completion of the action at the first coining station 11, excess metal material is trimmed away from the metal blank 9 and the resulting cross section of the metal blank is equal to the cross section of the finished product. The bandolier 10 then carries the metal blank 9 to the second coining station 12.

### Second Coining Station

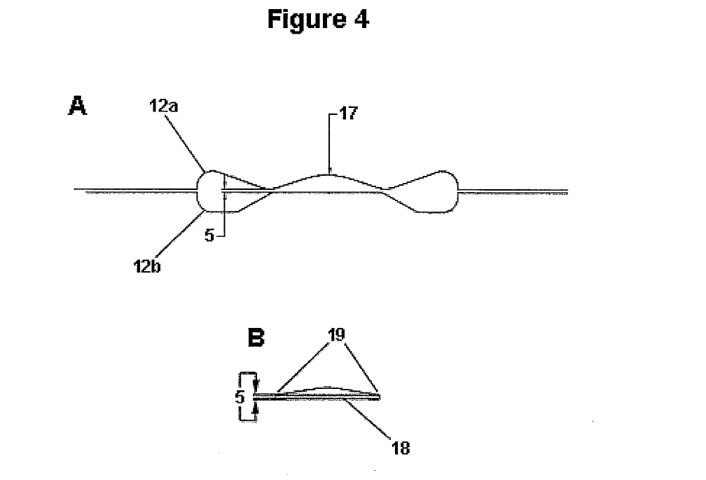

The second coining station 12 of the progressive die comprising an upper coining die 12a and a lower coining die 12b is show generally in FIG. 2 and in greater detail in FIG. 4A. The upper coining die 12a is shaped to provide the correct final cross section area and to promote the flow of material to the center 17. The lower coining die 12b is flat to promote material flow. FIG. 4B shows the profile 18 of the metal blank 9 following action of the second coining station 12 wherein the edges 19 have a thickness 5 that matches the thickness of the finished product 1. The bandolier 10 then carries the metal blank 9 to the third coining station 13.

### Third Coining Station

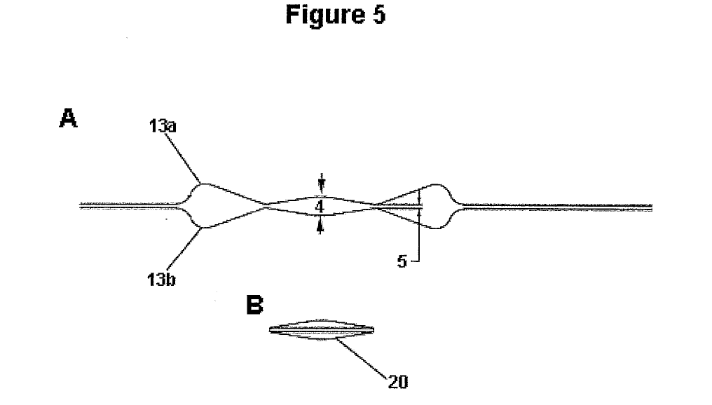

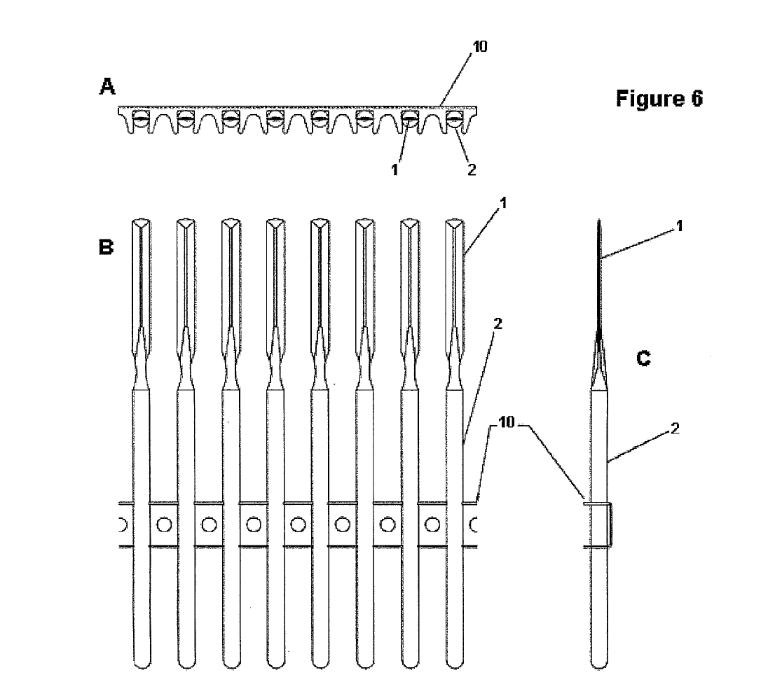

The third coining station 13 of the progressive die comprising an upper coining die 13a and a lower coining die 13b is shown generally in FIG. 2 and in greater detail in FIG. 5A. The third coining station 13 reforms the metal blank 9 to the final shape and required dimensions. FIG. 5B shows the profile 20 of the finished product 1. The first and second coining stations 11 and 12 established the conditions allowing the flow of material to the center 17 at the third coining station 13 providing the desired edge thickness 5 and blade thickness 4. FIGS. 6A-C show the finished blade 1 mounted on a typical bandolier 10 at the blade handle 2. The bandolier 10 containing the finished blades 1 may be coiled for subsequent processing.

### Machining Tools

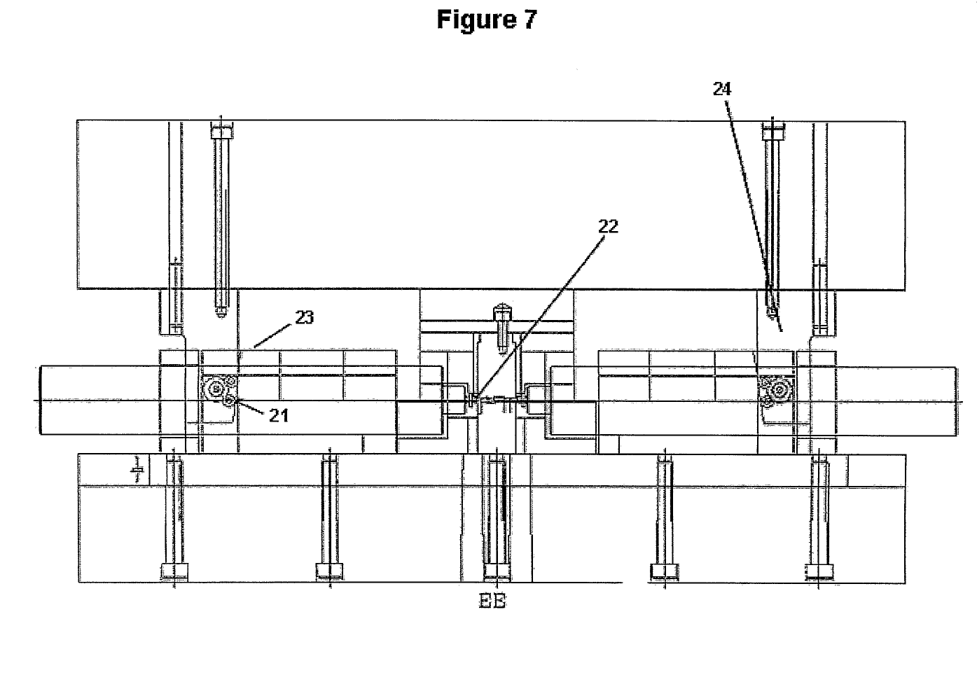

The bandolier 10 secures and provides control to the product so the manufacturer can automate additional manufacturing steps such as machining. Machining tools capable of forming machined edges with a well-defined surface finish may be applied to the finished blades 1 following processing at the third coining station 13. FIG. 7 shows machining tools that may be comprised of an electronic or air operated spindle 21 that turns a carbide cutting tool 22. The spindle 21 may be mounted on a slide 23 moved by a cam 24 with a profile that drives in the spindle 21 at a rate per tooth controlled by the spindle rpm and dwells the correct amount at the end of the stroke. This tooling allows for machining radii on the ends of the product produced. The addition of a machining process allows for greater precision in parts with machined edges and a surface finish that would be difficult to achieve using die stamping alone.

### Additional Processing

The bandolier assembly may also facilitate the automation of other processes including plating specific portions of the blade 1 with gold or other secondary operations such as cleaning and/or assembly.

The progressive die of the present invention, which replaces the hand-operated, single-hit methods, allows for mass production of precision metal instruments exhibiting a high degree of flexibility and consistency in edge characteristics. This automated, progressive approach increases production that allows precision metal instruments to be produced more efficiently and effectively reducing variance resulting in superior quality. The reduced tonnage requirements described above increase the life span of the dies and allow use of lighter, less expensive parts resulting in even greater cost savings.

What is claimed is:

1. A method of manufacturing precision metal devices or parts comprising the steps of:
feeding a starting metal material into a progressive die;
cutting said metal material to length forming a metal blank;
attaching said metal blank to a transporting means transporting said metal blank to a first coining station via said transporting means wherein said metal blank is coined forming an hourglass (concave) profile;
trimming excess metal material from said metal blank;
transporting said metal blank with said hourglass profile to a second coining station via said transporting means wherein said metal blank is coined forming a semi convex profile with a flat lower portion;
transporting said metal blank with said semi convex profile to a third coining station via said transporting means wherein said metal blank is coined forming a convex profile.

2. The method of claim 1 wherein said precision metal devices or parts are surgical blades.

3. The method of claim 1 wherein said transporting means is a bandolier.

4. The method of claim 1 wherein said metal blank forms said hourglass (concave) profile at first coining station in a single hit.

5. The method of claim 1 wherein said first coining station coins said metal blank to a medial thickness thinner than a medial thickness of said metal blank having a convex profile.

6. The method of claim 5 wherein first coining station coins said metal blank to a medial thickness that is 75% the medial thickness of said metal blank having a convex profile.

7. The method of claim 5 wherein first coining station coins said metal blank to a medial thickness that is less than 75% the thickness of said metal blank having a convex profile.

8. The method of claim 1 wherein said metal blank is machined within the progressive die to a specified curvature after exiting third coining station.

9. The method of claim 1 wherein said bandolier carrying metal blank having a convex profile is coiled for further processing.

10. The processing of claim 9 comprising cleaning said metal blank.

11. The processing of claim 9 comprising plating specific portions of said metal blank with gold.

12. An apparatus for manufacturing precision metal devices or parts comprising a progressive die further comprising:
a metal stock feeder;
a transporting means;
a first coining station for coining an hourglass (concave) profile into a metal blank;
a second coining station for coining a semi convex profile into a metal blank;
a third coining station for coining a convex profile into a metal blank.

13. A metal device or part manufactured by the method of claim 1.

14. The metal device or part of claim 13 having an hourglass (concave) profile.

15. The metal device or part of claim 13 having a semi convex profile.

16. The metal device or part of claim 13 having a convex profile.

17. The apparatus of claim 12 wherein said transporting means is a bandolier.
